(19) United States
(12) Patent Application Publication
(10) Pub. No.: US 2017/0285422 A1
(43) Pub. Date: Oct. 5, 2017

(54) LIQUID CRYSTAL DISPLAY DEVICE

(71) Applicant: Sharp Kabushiki Kaisha, Sakai City, Osaka (JP)

(72) Inventors: Iori AOYAMA, Sakai City (JP); Takahiro SASAKI, Sakai City (JP); Yuichi KITA, Sakai City (JP); Kazutaka HANAOKA, Sakai City (JP)

(21) Appl. No.: 15/507,799

(22) PCT Filed: Aug. 20, 2015
(86) PCT No.: PCT/JP2015/073373

§ 371 Date: Mar. 1, 2017

(30) Foreign Application Priority Data
Sep. 2, 2014 (JP) 2014-178255

(51) Int. Cl. G02F 1/1343; G02F 1/1335; G02F 1/1333

(52) U.S. Cl. CPC G02F 1/134363; G02F 1/134336; G02F 1/133345; G02F 1/133621; G02F 2001/134381; G02F 2001/133622

(57) ABSTRACT

A first substrate (10) in a liquid crystal display device (100) includes a first electrode (11) provided in each pixel and a second electrode (12) generating a lateral electric field in a liquid crystal layer (30) together with the first electrode. A second substrate (20) includes a third electrode (21) generating a vertical electric field in the liquid crystal layer together with the first electrode and the second electrode. Each pixel exhibits, in a switched manner, a black display state where black display is provided in a state where the vertical electric field is generated in the liquid crystal layer, a white display state where white display is provided in a state where the lateral electric field is generated in the liquid crystal layer, and a transparent display state where a rear side of a liquid crystal display panel (1) is seen through in a state where no voltage is applied to the liquid crystal layer. The first electrode (11) includes first and second linear portions (11b) located parallel to each other with a gap being provided therebetween and a protruding portion (11c) protruding from one of the first and second linear portions toward the other linear portion.

### TECHNICAL FIELD

The present invention relates to a liquid crystal display device, and specifically, to a liquid crystal display device preferably usable as a see-through display device.

### BACKGROUND ART

Recently, a see-through display device is a target of attention as a display device for information display or digital signage. Such a see-through display device allows the background (rear side of a display panel) to be seen through, and thus is capable of displaying information displayed on the display panel and the background in an overlapping manner. Therefore, the see-through display device has a splendid effect of appealing to potential customers and a splendid eye-catching effect. It has also been proposed to use the see-through display device for a showcase or a shop window.

In the case where a liquid crystal display device is used as a see-through display device, there is a bottleneck that the liquid crystal display device has a low light utilization factor. Such a low light utilization factor is caused by a color filter or a polarization plate provided in a general liquid crystal display device. The color filter and the polarization plate absorb light of a specific wavelength range or light of a specific polarization direction.

In such a situation, it is conceivable to use a liquid crystal display device of a field sequential system. In the field sequential system, the color of light directed from an illumination element toward a liquid crystal display panel is switched in a time division system to provide color display. Therefore, the color filter is not needed, and thus the light utilization factor is improved. However, the field sequential system requires a liquid crystal display device to have a high speed response.

Patent Document 1 and Patent Document 2 each disclose a liquid crystal display device having an improved response characteristic by including an electrode structure capable of generating a vertical electric field and a lateral electric field in a switched manner in a liquid crystal layer. In the liquid crystal display device disclosed in each of Patent Document 1 and Patent Document 2, a vertical electric field is generated in the liquid crystal layer in one of a transition from a black display state to a white display state (rise) and a transition from the white display state to the black display state (fall), and a lateral electric field (fringe field) is generated in the liquid crystal layer in the other of the rise and the fall. Therefore, a torque by voltage application acts on liquid crystal molecules in both of the rise and the fall, and thus a high speed response characteristic is provided.

Patent Document 3 also proposes a liquid crystal display device realizing a high speed response by causing an alignment control force, provided by an electric field, to act on the liquid crystal molecules in both of the rise and the fall.

### CITATION LIST

### Patent Literature

Patent Document 1: PCT Japanese National-Phase Laid-Open Patent Publication No. 2006-523850

Patent Document 2: Japanese Laid-Open Patent Publication No. 2002-365657

Patent Document 3: WO2013/001979

### SUMMARY OF INVENTION

### Technical Problem

However, it has been found that use of the liquid crystal display device disclosed in each of Patent Documents 1, 2 and 3 as a see-through display device causes a problem that the background is blurred (visually recognized double or seen double) for the reasons described below in detail and thus the display quality is declined. Patent Document 1, 2 or 3 does not described such a use (application as a see-through display device). The occurrence of the above-described problem is knowledge newly found by the present inventors.

The present invention made in light of the above-described problem has an object of providing a liquid crystal display device that has a high response characteristic and also provides a high display quality and is preferably usable as a see-through display device.

### Solution to Problem

A liquid crystal display device in an embodiment according to the present invention includes a liquid crystal display panel including a first substrate and a second substrate facing each other, and a liquid crystal layer provided between the first substrate and the second substrate; the liquid crystal display device including a plurality of pixels arrayed in a matrix. The first substrate includes a first electrode provided in each of the plurality of pixels and a second electrode provided below the first electrode with an insulating layer being provided between the first electrode and the second electrode, the second electrode generating a lateral electric field in the liquid crystal layer together with the first electrode. The second substrate includes a third electrode provided to face the first electrode and the second electrode, the third electrode generating a vertical electric field in the liquid crystal layer together with the first electrode and the second electrode. The plurality of pixels each exhibit, in a switched manner, a black display state where black display is provided in a state where the vertical electric field is generated in the liquid crystal layer, a white display state where white display is provided in a state where the lateral electric field is generated in the liquid crystal layer, and a transparent display state where a rear side of the liquid crystal display panel is seen through in a state where no voltage is applied to the liquid crystal layer. The first electrode includes first and second linear portions located parallel to each other with a gap being provided therebetween and a protruding portion protruding from one of the first linear portion and the second linear portion toward the other of the first linear portion and the second linear portion.

In an embodiment, a plurality of the protruding portions are provided in a direction in which the first linear portion extends.

In an embodiment, the plurality of protruding portions are located at substantially the same pitch.

In an embodiment, the first electrode further includes a third linear portion located on a side opposite to the first linear portion with respect to the second linear portion, the third linear portion being located parallel to the second linear portion and with a gap being provided between the second linear portion and the third linear portion; and a protruding portion protruding from one of the second linear portion and the third linear portion toward the other of the second linear portion and the third linear portion.

In an embodiment, the protruding portion provided between the first linear portion and the second linear portion, and the protruding portion provided between the second linear portion and the third linear portion, are located at positions shifted from each other with respect to a direction perpendicular to a direction in which the first, second and third linear portions extend.

In an embodiment, the protruding portion protruding from the one of the linear portions does not reach the other of the linear portions.

In an embodiment, the first electrode further includes a protruding portion protruding from the other of the linear portions toward the one of the linear portions.

In an embodiment, the protruding portion protruding from the one of the linear portions toward the other of the liner portions, and the protruding portion protruding from the other of the linear portions toward the one of the linear portions, face each other.

In an embodiment, the one of the linear portions has a recessed portion recessed in a direction from the other of the linear portions toward the one of the linear portions.

In an embodiment, liquid crystal molecules in the liquid crystal layer assume twisted alignment in the transparent display state.

In an embodiment, the first electrode includes a plurality of slits extending in a predetermined direction; and in the white display state and the transparent display state, liquid crystal molecules at, and in the vicinity of, a central portion of the liquid crystal layer in a thickness direction are aligned to be generally perpendicular to the predetermined direction.

In an embodiment, the liquid crystal display device further includes an illumination element directing light of a plurality of colors including red light, green light and blue light in a switched manner toward the liquid crystal display panel.

In an embodiment, the liquid crystal display device provides color display in a field sequential system.

In an embodiment, the liquid crystal display panel does not include a color filter.

### Advantageous Effects of Invention

An embodiment of the present invention provides a liquid crystal display device that has a high response characteristic and also provides a high display quality and is preferably usable as a see-through display device.

### BRIEF DESCRIPTION OF DRAWINGS

FIG. 1 is a cross-sectional view schematically showing a liquid crystal display device 100 in an embodiment according to the present invention.

FIG. 2 is a plan view schematically showing the liquid crystal display device 100 in the embodiment according to the present invention.

FIG. 3 is a plan view showing an example of specific line structure of a rear substrate 10 in the liquid crystal display device 100.

FIG. 4(a) and FIG. 4(b) are respectively a cross-sectional view and a plan view showing an alignment state of liquid crystal molecules 31 in a black display state of the liquid crystal display device 100.

FIG. 5(a) and FIG. 5(b) are respectively a cross-sectional view and a plan view showing an alignment state of the liquid crystal molecules 31 in a white display state of the liquid crystal display device 100.

FIG. 6(a) and FIG. 6(b) are respectively a cross-sectional view and a plan view showing an alignment state of the liquid crystal molecules 31 in a transparent display state of the liquid crystal display device 100.

FIG. 7 is a cross-sectional view showing an alignment state of the liquid crystal molecules 31 in a halftone display state of the liquid crystal display device 100.

FIG. 8 provides cross-sectional views schematically showing a liquid crystal display device 800 in a comparative example; FIG. 8(a) shows a black display state, and FIG. 8(b) shows a white display state.

FIG. 9 schematically shows that the display is blurred (visually recognized double).

FIG. 10 shows how alignment abnormality is caused from an end or the vicinity thereof of a linear portion included in an electrode when a strong lateral electric field is generated.

FIG. 11 is a plan view showing a structure of a first electrode included in a liquid crystal display device 110 in an embodiment according to the present invention.

FIG. 12(a) is a plan view showing a structure of a first electrode in another embodiment, and FIG. 12(b) is a plan view showing an alignment state of liquid crystal molecules in the state where the electrode structure in FIG. 12(a) is used.

FIG. 13(a) is a plan view showing a structure of a first electrode in still another embodiment, and FIG. 13(b) is a plan view showing an alignment state of liquid crystal molecules in the state where the electrode structure in FIG. 13(a) is used.

FIG. 14(a) is a plan view showing a structure of a first electrode in still another embodiment, and FIG. 14(b) is a plan view showing an alignment state of liquid crystal molecules in the state where the electrode structure in FIG. 14(a) is used.

FIG. 15(a) is a plan view showing a structure of a first electrode in still another embodiment, and FIG. 15(b) is a plan view showing an alignment state of liquid crystal molecules in the state where the electrode structure in FIG. 15(a) is used.

FIG. 16(a) is a plan view showing a structure of a first electrode in still another embodiment, and FIG. 16(b) is a plan view showing an alignment state of liquid crystal molecules in the state where the electrode structure in FIG. 16(a) is used.

FIG. 17 is a cross-sectional view schematically showing another liquid crystal display device 100′ in an embodiment according to the present invention.

FIG. 18 is a plan view schematically showing the another liquid crystal display device 100′ in the embodiment according to the present invention.

FIG. 19(a) and FIG. 19(b) are respectively a cross-sectional view and a plan view showing an alignment state of liquid crystal molecules 31 in a black display state of the liquid crystal display device 100′.

FIG. 20(a) and FIG. 20(b) are respectively a cross-sectional view and a plan view showing an alignment state of the liquid crystal molecules 31 in a white display state of the liquid crystal display device 100′.

FIG. 21(a) and FIG. 21(b) are respectively a cross-sectional view and a plan view showing an alignment state of the liquid crystal molecules 31 in a transparent display state of the liquid crystal display device 100′.

FIG. 22(a) and FIG. 22(b) are respectively an isometric view and a cross-sectional view schematically showing another structure of the liquid crystal display device 100.

### DESCRIPTION OF EMBODIMENTS

Hereinafter, embodiments of the present invention will be described with reference to the drawings. The present invention is not limited to any of the following embodiments.

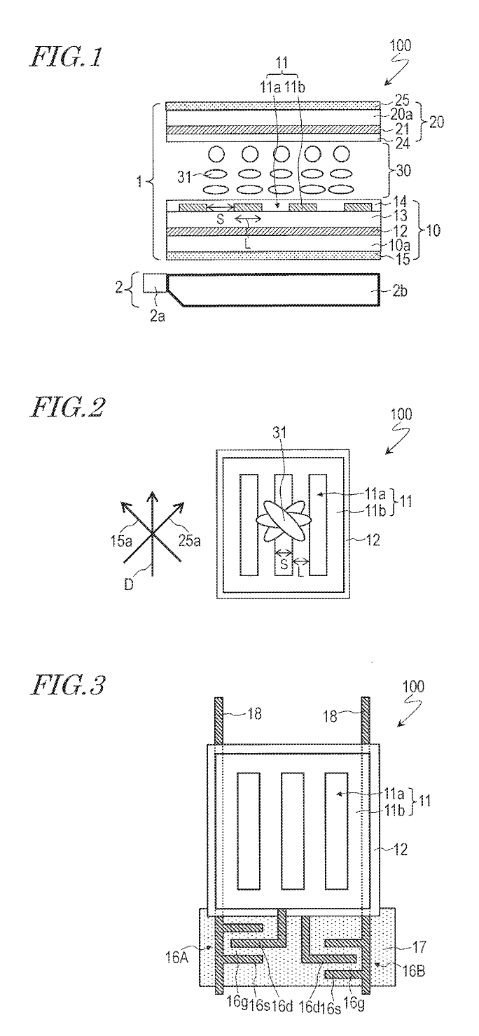

With reference to FIG. 1 and FIG. 2, a liquid crystal display device 100 in this embodiment will be described. FIG. 1 is a cross-sectional view schematically showing the liquid crystal display device 100, and FIG. 2 is a plan view schematically showing the liquid crystal display device 100.

As shown in FIG. 1, the liquid crystal display device 100 includes a liquid crystal display panel 1 and an illumination element 2. The liquid crystal display device 100 includes a plurality of pixels arrayed in a matrix. As described below, the liquid crystal display device 100 provides color display in a field sequential system.

The liquid crystal display panel 1 includes a first substrate 10 and a second substrate 20 facing each other, and a liquid crystal layer 30 provided between the first substrate 10 and the second substrate 20. Among the first substrate 10 and the second substrate 20, the first substrate 10 located relatively on a rear side will be referred to as a “rear substrate”, and the second substrate 20 located relatively on a front side will be referred to as a “front substrate”.

The rear substrate 10 includes a first electrode 11 provided in each of the plurality of pixels, and a second electrode 12 generating a lateral electric field in the liquid crystal layer 30 together with the first electrode 11. The first electrode 11 is located above the second electrode 12 with an insulating layer 13 being provided therebetween. In other words, the second electrode 12 is located below the first electrode 11 with the insulating layer 13 being provided therebetween. In the following description, among the first electrode 11 and the second electrode 12, the first electrode 11 located relatively on the upper side will be referred to as an “upper electrode” and the second electrode 12 located relatively on the lower side will be referred to as a “lower electrode”. The lower electrode 12, the insulating layer 13 and the upper electrode 11 are supported by a transparent substrate (e.g., glass substrate) 10a having an insulating property.

As shown in FIG. 1 and FIG. 2, the upper electrode 11 includes a plurality of slits 11a extending in a predetermined direction D and a plurality of linear portions 11b extending parallel to the direction D in which the slits 11a extend (hereinafter, the direction D will also be referred to as a “slit direction”). The number of the slits 11a and the linear portions 11b are not limited to those shown in FIG. 1 and FIG. 2. There is no specific limitation on width S of each of the slits 11a. The width S of each slit 11a is typically 2 μm or greater and 10 μm or less. There is no specific limitation either on width L of each of the linear portions 11b. The width L of each linear portion 11b is typically 2 μm or greater and 10 μm or less. The upper electrode 11 is formed of a transparent conductive material (e.g., ITO).

The lower electrode 12 does not include any slit. Namely, the lower electrode 12 is a so-called solid electrode. The lower electrode 12 is formed of a transparent conductive material (e.g., ITO).

There is no specific limitation on the material of the insulating layer 13. The insulating layer 13 may be formed of, for example, an inorganic material such as silicon oxide (SiO₂), silicon nitride (SiNₓ) or the like or an organic material such as a photosensitive resin or the like.

The front substrate 20 includes a third electrode 21 provided to face the upper electrode (first electrode) 11 and the lower electrode (second electrode) 12 (hereinafter, the third electrode will be referred to as a “counter electrode”). The counter electrode 21 is supported by a transparent substrate (e.g., glass substrate) 20a having an insulating property.

The counter electrode 21 generates a vertical electric field in the liquid crystal layer 30 together with the upper electrode 11 and the lower electrode 12. The counter electrode 21 is formed of a transparent conductive material (e.g., ITO).

Although not shown in FIG. 1, a dielectric layer (overcoat layer) may be formed on the counter electrode 21. The overcoat layer is provided to weaken the vertical electric field unavoidably generated when the lateral electric field is generated. The overcoat layer is formed of, for example, a photosensitive resin.

The liquid crystal layer 30 contains liquid crystal molecules 31 having positive dielectric anisotropy. Namely, the liquid crystal layer 30 is formed of a positive liquid crystal material. In FIG. 1 and FIG. 2, the liquid crystal molecules 31 are aligned in the state where no voltage is applied to the liquid crystal layer 30.

The liquid crystal display panel 1 further includes a pair of horizontal alignment films 14 and 24 provided to face each other with the liquid crystal layer 30 being provided therebetween. One of the pair of horizontal alignment films 14 and 24, specifically, the horizontal alignment film 14 (hereinafter, may be referred to as a “first horizontal alignment film”), is formed on a surface of the rear substrate 10 on the side of the liquid crystal layer 30. The other of the pair of horizontal alignment films 14 and 24, specifically, the horizontal alignment film 24 (hereinafter, may be referred to as a “second horizontal alignment film”), is formed on a surface of the front substrate 20 on the side of the liquid crystal layer 30.

The first horizontal alignment film 14 and the second horizontal alignment film 24 are each alignment-processed and thus have an alignment control force that aligns the liquid crystal molecules 31 in the liquid crystal layer 30 in a predetermined direction (referred to as a “pretilt direction”). The alignment process may be, for example, a rubbing process or an optical alignment process.

The pretilt directions respectively controlled by the first horizontal alignment film 14 and the second horizontal alignment film 24 are set such that the liquid crystal molecules 31 assume twisted alignment in the state where no voltage is applied to the liquid crystal layer 30 (in the state where no electric field is generated). Specifically, the pretilt directions respectively controlled by the first horizontal alignment film 14 and the second horizontal alignment film 24 have an angle of about 45 degrees with respect to the slit direction D. The pretilt direction controlled by the second horizontal alignment film 24 has an angle of 90 degrees with respect to the pretilt direction controlled by the first horizontal alignment film 14. Therefore, in the state where no voltage is applied to the liquid crystal layer 30, the liquid crystal molecules 31 are twisted at 90 degrees.

The liquid crystal display panel 1 further includes a pair of polarization plates 15 and 25 provided to face each other with the liquid crystal layer 30 being provided therebetween. One of the pair of polarization plates 15 and 25, specifically, the polarization plate 15 (hereinafter, also referred to a “first polarization plate”), has a transmission axis (polarization axis) 15a, and the other of the pair of polarization plates 15 and 25, specifically, the polarization plate 25 (hereinafter, also referred to as a “second polarization plate”), has a transmission axis (polarization axis) 25a. As shown in FIG. 2, the transmission axes 15a and 25a are generally perpendicular to each other. Namely, the polarization plates 15 and 25 are located in a crossed-Nicols state. The transmission axis 15a of the first polarization plate 15 and the transmission axis 25a of the second polarization plate 25 are generally parallel or generally perpendicular to the pretilt directions respectively controlled by the first horizontal alignment film 14 and the second horizontal alignment film 24. Therefore, the transmission axis 15a of the first polarization plate 15 and the transmission axis 25a of the second polarization plate 25 each have an angle of about 45 degrees with respect to the slit direction D.

The illumination element (also referred to as a “backlight unit”) 2 is located on the rear side of the liquid crystal display panel 1. The illumination element 2 is capable of directing light of a plurality of colors including red light, green light and blue light in a switched manner toward the liquid crystal display panel 1.

The illumination element 2 may be, for example, of an edge light system as shown in FIG. 1. The illumination element 2 of the edge light system includes a light source unit 2a and a light guide plate 2b. The light source unit 2a may emit light of a plurality of colors including red light, green light and blue light. The light source unit 2a includes, for example, a red LED, a green LED and a blue LED. The light guide plate 2b guides the color light emitted from the light source unit 2a toward the liquid crystal display panel 1.

The liquid crystal display device 100 provides color display in the field sequential system. Therefore, the liquid crystal display panel 1 does not include any color filter.

When a predetermined voltage is applied between the upper electrode 11 and the lower electrode 12 (namely, when a predetermined potential difference between the upper electrode 11 and the lower electrode 12 is given), a lateral electric field (fringe field) is generated in the liquid crystal layer 30. The “lateral electric field” is an electric field including a component parallel to the substrate surface. The direction of the lateral electric field generated by the upper electrode 11 and the lower electrode 12 is generally perpendicular to the slit direction D.

By contrast, when a predetermined voltage is applied between the counter electrode 21 and the upper electrode 11/lower electrode 12 (namely, when a predetermined potential difference between the counter electrode 21 and the upper electrode 11/lower electrode 12 is given), a vertical electric field is generated. The “vertical electric field” is an electric field directed generally parallel to the normal to the substrate surface.

The liquid crystal display device 100 has a structure capable of controlling the strength of each of the lateral electric field and the vertical electric field for each of the pixels. Typically, the liquid crystal display device 100 has a structure capable of supplying a different voltage to each of the upper electrode 11 and the lower electrode 12 on a pixel-by-pixel basis. Specifically, the upper electrode 11 and the lower electrode 12 are both provided for each of the pixels, and each pixel includes a switching element (e.g., thin film transistor; not shown) electrically connected with the upper electrode 11 and a switching element (e.g., thin film transistor; not shown) electrically connected with the lower electrode 12. Predetermined voltages are respectively supplied to the upper electrode 11 and the lower electrode 12 via the corresponding switching elements. The counter electrode 21 is formed as a single continuous conductive film corresponding to all the pixels. Therefore, a common potential is applied to the counter electrode 21 in all the pixels.

FIG. 3 shows an example of specific line structure of the rear substrate 10. In the structure shown in FIG. 3, each pixel includes a first TFT 16A corresponding to the upper electrode 11 and a second TFT 16B corresponding to the lower electrode 12.

A gate electrode 16g of each of the first TFT 16A and the second TFT 16B is electrically connected with a gate bus line (scanning line) 17. A portion of the gate bus line 17 that overlaps a channel region of each of the first TFT 16A and the second TFT 16B acts as the gate electrodes 16g. Source electrodes 16s of the first TFT 16A and the second TFT 16B are electrically connected with source bus lines (signal line) 18 respectively. A portion branched from each of the source bus lines 18 acts as the source electrode 16s. A drain electrode 16d of the first TFT 16A is electrically connected with the upper electrode 11. By contrast, a drain electrode 16d of the second TFT 16B is electrically connected with the lower electrode 12. The line structure of the rear substrate 10 is not limited to that shown in FIG. 3.

In the liquid crystal display device 100 in this embodiment, each of the plurality of pixels may exhibit, in a switched manner, a “black display state” in which black display is provided in the state where a vertical electric field is generated in the liquid crystal layer 30, a “white display state” in which white display is provided in the state where a lateral electric field is generated in the liquid crystal layer 30, and a “transparent display state” in which the rear side of the liquid crystal display panel 1 (i.e., background) is seen through in the state where no voltage is applied to the liquid crystal layer 30.

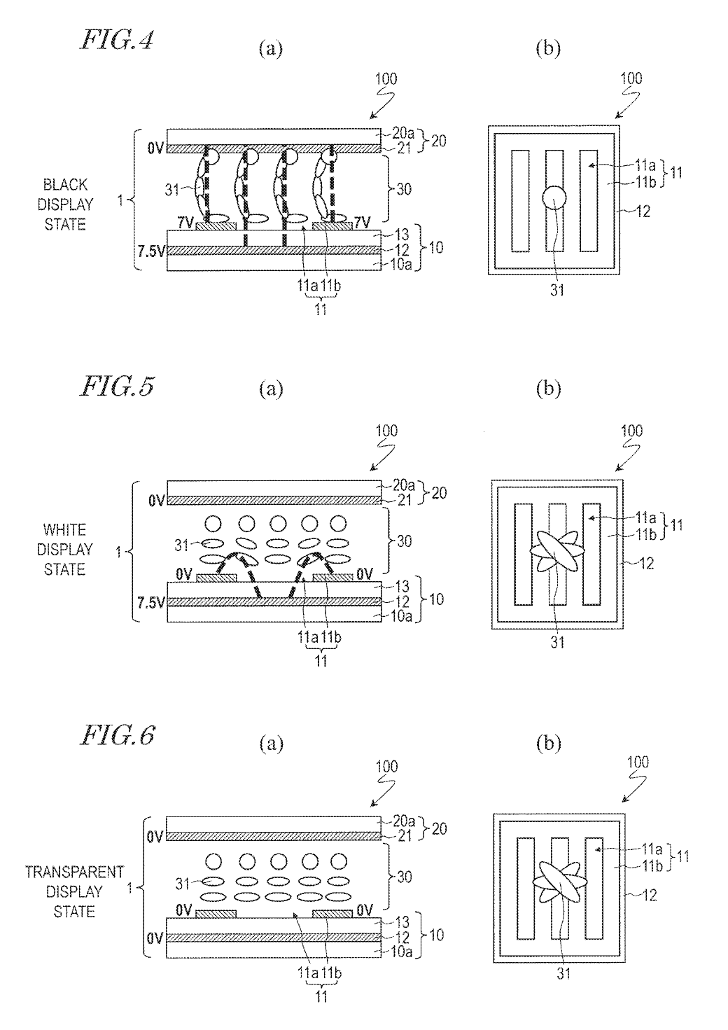

Hereinafter, with reference to FIG. 4, FIG. 5 and FIG. 6, the black display state, the white display state and the transparent display state will be described in more detail.

FIG. 4(a) and FIG. 4(b) each show an alignment state of the liquid crystal molecules 31 in the black display state. In the black display state, a predetermined voltage is applied between the counter electrode 21 and the upper electrode 11/lower electrode 12 (for example, potentials of 7 V, 7.5 V and 0 V are given to the upper electrode 11, the lower electrode 12 and the counter electrode 21 respectively), and a vertical electric field is generated in the liquid crystal layer 30. FIG. 4(a) schematically shows lines of electric force in this state with dashed lines.

In the black display state, as shown in FIG. 4(a) and FIG. 4 (b), the liquid crystal molecules 31 in the liquid crystal layer 30 are aligned to be generally vertical to the substrate surface (surfaces of the rear substrate 10 and the front substrate 20) (namely, aligned to be generally parallel to the normal to the liquid crystal layer 30). The liquid crystal molecules 31 in the close vicinity of the first horizontal alignment film 14 and the second horizontal alignment film 24 are strongly influenced by the alignment control force of the first horizontal alignment film 14 and the second horizontal alignment film 24 and thus are kept aligned to be generally parallel to the substrate surface. However, such liquid crystal molecules 31 are generally parallel or generally perpendicular to the transmission axis 15a of the first polarization plate 15, and thus do not give phase difference almost at all to light incident on the liquid crystal layer 30 via the first polarization plate 15 and do not decrease the contrast ratio almost at all.

FIG. 5(a) and FIG. 5(b) each show an alignment state of the liquid crystal molecules 31 in the white display state. In the white display state, a predetermined voltage is applied between the upper electrode 11 and the lower electrode 12 (for example, potentials of 0 V, 7.5 V and 0 V are given to the upper electrode 11, the lower electrode 12 and the counter electrode 21 respectively), and a lateral electric field (fringe field) is generated in the liquid crystal layer 30. FIG. 5(a) schematically shows lines of electric force in this state with dashed lines.

In the white display state, as shown in FIG. 5(a) and FIG. 5 (b), the liquid crystal molecules 31 in the liquid crystal layer 30 are aligned to be generally parallel to the substrate surface (namely, aligned to be generally vertical to the normal to the liquid crystal layer 30). More specifically, the liquid crystal molecules 31 in the vicinity of the first horizontal alignment film 14 and the liquid crystal molecules 31 in the vicinity of the second horizontal alignment film 24 are aligned to have an angle of about 90 degrees with respect to each other. As a result, the liquid crystal molecules 31 at, and in the vicinity of, a central portion of the liquid crystal layer 30 in a thickness direction are aligned to be generally perpendicular to the direction D in which the slits 11a of the upper electrode 11 extend (generally perpendicular in the slit direction D). Therefore, the average alignment direction of the bulk liquid crystal portion is generally perpendicular to the slit direction D (namely, has an angle of about 45 degrees with respect to the transmission axes 15a and 25a of the first polarization plate 15 and the second polarization plate 25).

FIG. 6(a) and FIG. 6(b) each show an alignment state of the liquid crystal molecules 31 in the transparent display state. In the transparent display state, no voltage is applied to the liquid crystal layer 30 (for example, a potential of 0 V is given to all of the upper electrode 11, the lower electrode 12 and the counter electrode 21), and neither a vertical electric field nor a lateral electric field is generated in the liquid crystal layer 30.

In the transparent display state, as shown in FIG. 6(a) and FIG. 6(b), the liquid crystal molecules 31 in the liquid crystal layer 30 assume twisted alignment. Namely, the liquid crystal molecules 31 are aligned to be generally parallel to the substrate surface (namely, generally vertical to the normal to the liquid crystal layer 30). The liquid crystal molecules 31 in the vicinity of the first horizontal alignment film 14 and the liquid crystal molecules 31 in the vicinity of the second horizontal alignment film 24 are aligned to have an angle of about 90 degrees with respect to each other. As a result, the liquid crystal molecules 31 at, and in the vicinity of, the central portion of the liquid crystal layer 30 in the thickness direction are aligned to be generally perpendicular to the slit direction D. Therefore, the average alignment direction of the bulk liquid crystal portion is generally perpendicular to the slit direction D (namely, has an angle of about 45 degrees with respect to the transmission axes 15a and 25a of the first polarization plate 15 and the second polarization plate 25). Each of the pixels in the liquid crystal display device 100 has a highest light transmittance in this transparent display state (namely, higher light transmittance than in the black display state or the white display state).

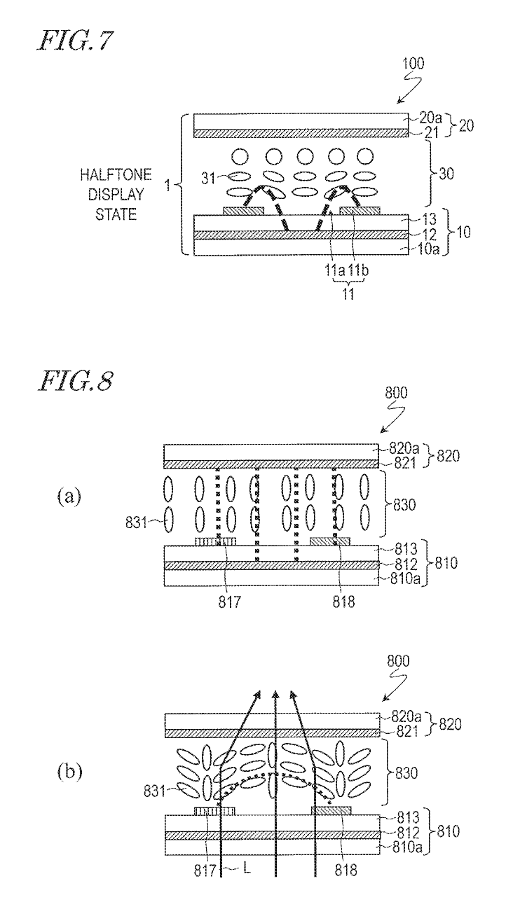

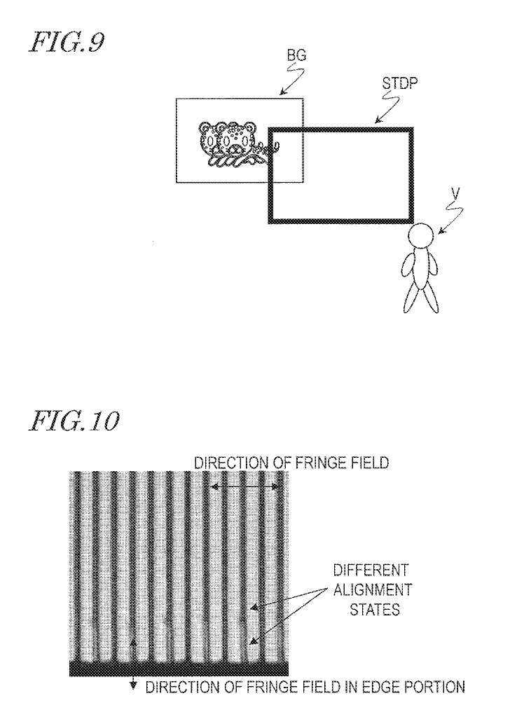

Each of the plurality of pixels in the liquid crystal display device 100 may exhibit a “halftone display state” in which display is provided at a luminance corresponding to a halftone as shown in FIG. 7, in addition to the black display state, the white display state and the transparent display state described above. In the halftone display state, a desired transmittance may be realized by adjusting the strength of the lateral electric field (fringe field) generated in the liquid crystal layer 30.

As described above, in the case where the liquid crystal display device 100 displays information displayed on the liquid crystal display panel 1 and the background in an overlapping manner, the pixels in a portion in the display region in which the information is to be displayed exhibit the black display state, the white display state or the halftone display state, and the pixels in the remaining portion exhibit the transparent display state. The display states are switched as follows, for example.

A driving circuit for a general liquid crystal display device includes an 8-bit driver IC, and generates an output voltage for 256 levels (levels 0 to 255). In a general liquid crystal display device, level 0 is assigned to the black display state, levels 1 through 254 are assigned to the halftone display state, and level 255 is assigned to the white display state.

In the liquid crystal display device 100 in this embodiment, for example, level 0 is assigned to the black display state, levels 1 through 253 are assigned to the halftone display state, level 254 is assigned to the white display state, and level 255 is assigned to the transparent display state. In this manner, the black display state, the halftone display state, the white display state and the transparent display state are switched to each other. It is not necessary that level 255 is assigned to the transparent display state. Any level may be assigned to the transparent display state. In a display system other than the above-described 256-level display system, a specific level may be assigned to the transparent display state.

As described above, the liquid crystal display device 100 in this embodiment provides color display in the field sequential system. Therefore, the liquid crystal display panel 1 does not need a color filter. This improves the light utilization factor. Also in the liquid crystal display device 100, a vertical electric field is generated in the liquid crystal layer 30 in the black display state and a lateral electric field is generated in the liquid crystal layer 30 in the white display state. Therefore, a torque by voltage application acts on liquid crystal molecules 31 in both of the fall (transition from the white display state to the black display state) and the rise (transition from the black display state to the white display state), and thus a high speed response characteristic is provided.

In the liquid crystal display device 100 in this embodiment, the pixels may each exhibit the transparent display state in which no voltage is applied to the liquid crystal layer 30, in addition to the black display state and the white display state. Displaying the background in the transparent display prevents the problem that the background is blurred (visually recognized double). Hereinafter, reasons why this problem (the display is blurred and visually recognized double) occurs in the liquid crystal display devices in Patent Documents 1 through 3 will be described by way of a liquid crystal display device in a comparative example.

FIG. 8(a) and FIG. 8(b) respectively show a liquid crystal display device 800 in a comparative example in the black display state and the white display state. The liquid crystal display device 800 in the comparative example has the same structure as that shown in FIG. 1 and FIG. 2 of Patent Document 3.

The liquid crystal display device 800 includes an array substrate 810, a counter substrate 820 and a liquid crystal layer 830 provided therebetween. The array substrate 810 includes a glass substrate 810a, and a lower electrode 812, an insulating layer 813 and a pair of comb electrodes (upper electrodes) 817 and 828 stacked on the glass substrate 810a in this order. Meanwhile, the counter substrate 820 includes a glass substrate 820a and a counter electrode 821 provided on the glass substrate 820a.

The liquid crystal layer 830 contains liquid crystal molecules 831 having positive dielectric anisotropy. In the liquid crystal display device 800, the liquid crystal molecules 831 in the liquid crystal layer 830 assume a vertical alignment state in the state where no voltage is applied.

In the liquid crystal display device 800 in the comparative example, for proving black display, a predetermined voltage is applied between the counter electrode 821 and the lower electrode 812/upper electrodes (pair of comb electrodes) 817 and 818 (for example, a potential of 7 V is given to the counter electrode 821, and a potential of 14 V is given to the lower electrode 812 and the upper electrodes 817 and 818), and a vertical electric field is generated in the liquid crystal layer 830. As a result, as shown in FIG. 8(a), the liquid crystal molecules 831 are aligned to be generally vertical to the substrate surface.

In the liquid crystal display device 800 in the comparative example, for proving white display, a predetermined voltage is applied between the pair of comb electrodes 817 and 818 (for example, a potential of 0 V is given to one of the comb electrodes, specifically, the comb electrode 817, and a potential of 14 V is given to the other of the comb electrodes, specifically, the comb electrode 818), and a lateral electric field is generated in the liquid crystal layer 830. As a result, as shown in FIG. 8 (b), the liquid crystal molecules 831 are aligned as being inclined with respect to the normal to the substrate surface.

In the case where the liquid crystal display device 800 in the comparative example is simply used as a see-through display device with no specific consideration, see-through display is provided, namely, display in which the background is seen though is provided, in the white display state in which the light transmittance of the pixels is high. However, the white display state is realized by applying a voltage to the liquid crystal layer 830 to align the liquid crystal molecules 831. Therefore, there occurs a refractive index distribution in each pixel. As a result, light L from the rear side is scattered (namely, the advancing direction of the light L is changed; see FIG. 8 (b)) by the refractive index distribution), and thus the background is blurred. As a result, as shown in FIG. 9, a viewer V viewing the background BG via a see-through display device STDP visually recognizes the background double.

As described above, when see-through display is provided in the white display state in which a voltage is applied to the liquid crystal layer, the display is blurred (visually recognized double). By contrast, the liquid crystal display device 100 in this embodiment provides background display (see-through display) in the state where no voltage is applied to the liquid crystal layer 30 (in the transparent display state). Therefore, a viewer viewing the background via the liquid crystal display device 100 visually recognizes the background clearly. Thus, the display is prevented from being blurred (from being visually recognized double), and the quality of the see-through display is improved.

<Embodiments in which a Protruding Portion (Narrow Slit Portion) is Provided Along the Linear Portion of the Upper Electrode)

As a result of active studies, the present inventors have confirmed that when a lateral electric field is generated in a liquid crystal display device as described above in which both of a lateral electric field and a vertical electric field may be generated in a liquid crystal layer, abnormality is caused to the alignment of the liquid crystal molecules in a part of the liquid crystal layer. It has been found that especially in the case where the difference between a voltage applied to the upper electrode 11 (hereinafter, referred to as an “upper voltage”) and a voltage applied to the lower electrode 12 (hereinafter, referred to as a “lower voltage”) is large, an abnormal alignment change may occur at the time of gray scale level transition.

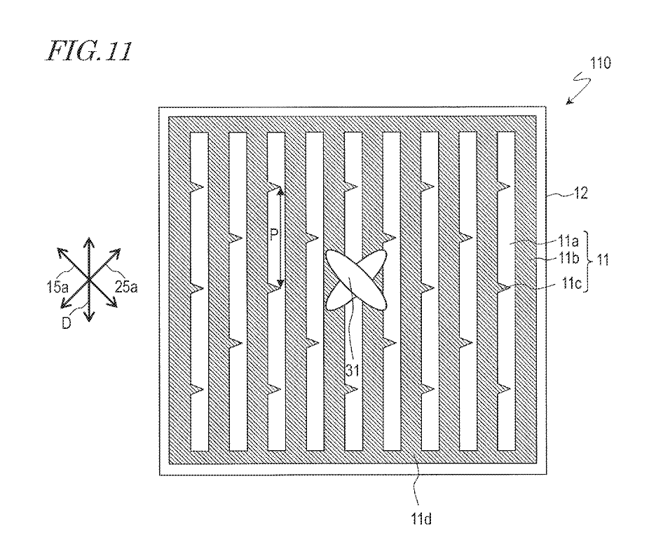

FIG. 10 shows an alignment state of the liquid crystal molecules when a fringe field (lateral electric field) is applied. In bright regions in the figure, the liquid crystal molecules are aligned such that light is easily transmitted through the liquid crystal display panel, and in the dark regions in the figure, the liquid crystal molecules are aligned such that light is not easily transmitted through the liquid crystal display panel. In the example shown in FIG. 10, the bright regions are formed on the linear portions 11b of the upper electrode 11 (see FIG. 1 through FIG. 3), and the dark regions are formed on the slits 11a.

It is seen from FIG. 10 that abnormality is caused to the alignment of the liquid crystal molecules located on the slits 11a in a peripheral region of the upper electrode 11, namely, in a region where ends of the linear portions 11b of the upper electrode 11 are connected with a peripheral region 11d (see FIG. 11) extending perpendicular to the linear portions 11b. In this specification, the region of the ends of the linear portions 11b may be referred to as an “edge portion” or a “pixel peripheral region”.

One conceivable reason why such alignment abnormality is caused is that a fringe field is generated in the edge portion of the upper electrode 11 in a different direction from in the remaining portion. More specifically, in the portion other than the edge portion, uniform fringe fields are generated in a direction generally perpendicular to the linear portions 11b. By contrast, in the edge portion, a fringe field is generated in, for example, the same direction as the linear portions 11b. The fringe field generated in the edge portion is presumed to easily cause the liquid crystal molecules to be aligned abnormally, especially in the case where the liquid crystal molecules are aligned in a vertical direction in addition to a planar direction. It has been confirmed by the present inventors that the above-described alignment abnormality is likely to occur especially in the case where a gray scale level is changed to a level at which the difference between the upper voltage and the lower voltage is relatively large (e.g., 5 V or greater).

The abnormal alignment change occurs at a visually recognizable speed (several hundred milliseconds to several seconds). The abnormal alignment change may occur such that a line runs from the pixel peripheral region to a central portion. The degree of abnormal alignment change varies inside each pixel and/or on a pixel-by-pixel basis. Therefore, the abnormal alignment change is observed as display non-uniformity or roughness, which declines the display quality. In the case where the degree of abnormal alignment change varies on a pixel-by-pixel basis, such a variance is observed as a brightness difference, and the display may be observed as being hazy.

FIG. 11 is a plan view showing a structure of a liquid crystal display device 110 having an electrode structure suppressing the decline in the display quality caused by the above-described alignment abnormality. Like, for example, the liquid crystal display device 100 shown in FIG. 1 through FIG. 3, the liquid crystal display device 110 includes an upper electrode 11 and a lower electrode 12 located below the upper electrode 11 with an insulating layer being provided therebetween.

In the liquid crystal display device 110, the upper electrode 11 includes a plurality of linear portions 11b provided parallel to each other with slits 11a being provided therebetween. Ends of the plurality of linear portions 11b are connected with an outer quadrangular frame region (peripheral region) 11d. In the example shown in FIG. 11, both ends of each of the linear portions 11b are connected with the peripheral region 11d. The upper electrode 11 is not limited to having such a structure. The upper electrode 11 may be formed to have a comb-like shape in which one of the two ends of each linear portion 11b is opened. In this case, lengthy cut-off portions are provided as the slits 11a between the linear portions 11b adjacent to each other.

The linear portions 11b each have a plurality of protruding portions 11c arrayed in a direction in which the linear portions 11b extend. Each of the protruding portions 11c protrudes from one of two adjacent linear portions 11b toward the other linear portion 11b. In the embodiment shown in FIG. 11, the protruding portions 11c are located along a right edge of each linear portion 11b and protrude toward a linear portion 11b adjacent thereto on the right. In an area where such a protruding portion 11c is provided, the width of the slit 11a is locally decreased.

Along each of the linear portions 11b, the plurality of protruding portions 11c are located equidistantly at a predetermined pitch. Along every two linear portions 11b adjacent to each other, the positions of the protruding portions 11c are shifted with respect to a direction perpendicular to the linear portions 11b in the plane (with respect to the horizontal direction in FIG. 11). More specifically, the plurality of protruding portions 11c are shifted by half of the pitch P of the protruding portions 11c. The pitch P of the protruding portions 11c may be optionally set in accordance with the size of the pixels and the speed of occurrence of the alignment abnormality. For example, the pitch P may be 40 μm or less or 20 μm or less. There is no specific limitation on the width of each linear portion 11b. The width of the linear portion 11b may be, for example, 2 μm or greater and 10 μm or less, and the width of each slit 11a may be, for example, 2 μm or greater and 10 μm or less, like in the liquid crystal display device 100 shown in FIG. 1.

The protruding portions 11c each merely need to protrude by, for example, 1 μm or greater toward the adjacent linear portion 11b. As long as the protruding portions 11c protrude to a certain degree, a fringe field similar to that in the edge portion is generated. Therefore, an abnormal alignment area similar to the edge portion is formed.

In the embodiment shown in FIG. 11, a tip of each protruding portion 11c does not reach the adjacent linear portion 11b. If the protruding portion 11c protrudes excessively, the abnormal alignment area formed around the protruding portion 11c may undesirably become too large. Therefore, the distance by which the protruding portion 11c protrudes may be suppressed to, for example, 80% or less of the width of the slit. In the case where the destruction of the alignment does not cause a problem in display, two adjacent linear portions 11b may be connected with each other by the protruding portion 11c acting as a bridge.

The protruding portions 11c have edges non-parallel to the direction in which the linear portions 11b extend. This is considered to generate a lateral electric field, having a similar directivity to that of the lateral electric field generated in the pixel peripheral region where the linear portions 11b and the peripheral region 11d are connected with each other, also in an area around the protruding portion 11c located in a pixel central region. Therefore, the alignment abnormality shown in FIG. 10 is prevented from occurring locally only in the pixel peripheral region, and thus a relatively uniform alignment state is realized in the entire pixel. In addition, the degree of abnormal alignment change is prevented from being varied among the pixels, and thus the brightness is prevented from being varied. As a result, the decline in the display quality caused by the alignment abnormality is alleviated, and display in which faults are not easily recognized is provided.

In the embodiment shown in FIG. 11, the protruding portions 11c each have a triangular shape having an apex protruding toward the adjacent linear portion 11b. The protruding portions 11c are not limited to having such a shape. The protruding portions 11c may have a generally triangular shape having two curved lines concaved inward or two curved lines convexed outward crossing each other at the apex, or may have a semicircular shape. The protruding portions 11c may have a trapezoidal shape or any polygonal shape. From the point of view of ease of production, it is preferable that the protruding portions 11c have a shape, as a whole, having a width decreasing toward the adjacent linear portion 11b.

As long as each linear portion 11b has at least one protruding portion 11c, an abnormal alignment area is formed from the at least one protruding portion 11c, and a certain effect is provided to form a uniform alignment in the entire pixel. However, in order to uniformize the alignment with more certainty, each linear portion 11b has preferably two or more protruding portions 11c, more preferably, three or more protruding portions 11c. A large number of points from which the abnormal alignment areas are formed may be provided in this manner, so that the decline in the display quality is suppressed more effectively. However, if the number of the protruding portions 11c is too large, the area usable for display may be decreased. Therefore, each linear portion 11b may have, for example, 100 or less protruding portions 11c.

FIG. 12(a) is a plan view showing an upper electrode 11 in another embodiment. Each linear portion 11b has a plurality of protruding portions 11c protruding to the adjacent linear portion 11b. Between the protruding portions 11c, the linear portion 11b also has recessed portions 11e recessed from edges of the linear portion 11b toward a center line thereof.

Now, referring to FIG. 12 (a), two adjacent liner portions 11b1 and 11b2 of the upper electrode 11 will be paid attention to. One of the linear portions, specifically, the linear portion 11b1, has the protruding portions 11c protruding therefrom toward the other linear portion 11b2. The linear portion 11b2 has the protruding portions 11c protruding therefrom toward the linear portion 11b1. The protruding portions 11c are located to face each other in the slit 11a provided between the liner portions 11b1 and 11b2. The width of the slit 11a is decreased in the area where the protruding portions 11c face each other.

FIG. 12(b) shows an alignment state of the liquid crystal molecules in the case where the upper electrode 11 shown in FIG. 12(a) is used. Like in FIG. 10, in the bright regions, the liquid crystal molecules are aligned such that light is easily transmitted through the liquid crystal display panel, and in the dark regions, the liquid crystal molecules are aligned such that light is not easily transmitted through the liquid crystal display panel.

In FIG. 12(a), an area where the protruding portions 11c face each other is enclosed by a circle. In FIG. 12(b), an area corresponding to the area enclosed by the circle in FIG. 12(a) is enclosed by a circle. It is seen from FIG. 12(b) that an alignment state, substantially the same as the alignment state caused in the peripheral region shown in FIG. 10, is realized on the slit 11a from the area where each protruding portion 11c is provided. It is observed that the regions of such an alignment state on the slit 11a are continuously provided, in the direction in the direction in which the linear portions 11b extend, from the area where the protruding portion 11c of attention is provided to an area where the adjacent protruding portion 11c is provided.

The protruding portions 11c are provided at a predetermined pitch in the entire pixel as shown in FIG. 12(a) and FIG. 12(b), so that the alignment state of the liquid crystal molecules in the pixel is made uniform. In the case where as shown in FIG. 12(a), the narrow portions of the slits 11a (namely, the areas where the protruding portions 11c face each other) are located to be shifted by half pitch between two adjacent slits 11a, the abnormal alignment regions, which are linear, are also formed to be shifted by half pitch as shown in FIG. 12(b). This may make the abnormal alignment regions less conspicuous. Alternatively, the narrow portions may be located in the same manner in two adjacent slits 11a, namely, may be arranged in a straight line extending in the direction perpendicular to the linear portions 11b.

As shown in FIG. 12(a), the recessed portions 11e (wide portions of the slit 11a) are provided between two adjacent protruding portions 11c in the direction in which the linear portions 11b extend. However, it is considered that as seen from FIG. 12(b), a fringe field generated in the recessed portion 11e does not act almost at all to change the alignment of the liquid crystal molecules. Therefore, it is not indispensable to provide the recessed portions 11e. The linear portions 11b each need to have at least the protruding portion 11c, so that the an effect of uniformizing the alignment in the pixel is provided, and brightness difference among the pixels is prevented from being observed.

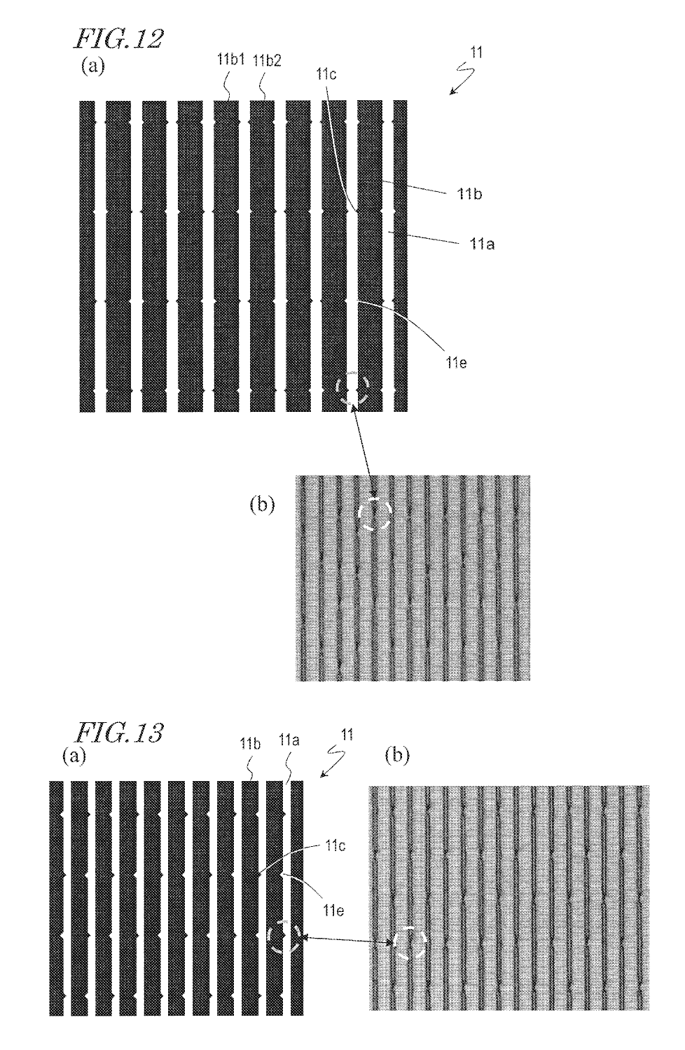

FIG. 13(a) and FIG. 14(a) are each a plan view showing an upper electrode 11 in still another embodiments. In the upper electrode 11 shown in each of FIG. 13(a) and FIG. 14(a), each linear portion 11b has a plurality of protruding portions 11c. Between the protruding portions 11c, the linear portion 11b also has recessed portions 11e recessed from an edge of the linear portion 11b toward a center line thereof. The recessed portions 11e are arranged in the direction in which the linear portion 11b extends. Unlike in the upper electrode 11 shown in FIG. 12(a), the protruding portions 11c and the recessed portions 11e located alternately are provided only along one edge among the left and right edges of each linear portion 11b. In FIG. 13(a), each linear portion 11b has the protruding portions 11c and the recessed portions 11e along the right edge thereof. In FIG. 14(a), each linear portion 11b has the protruding portions 11c and the recessed portions 11e along the left edge thereof.

As shown in FIG. 13 (b) and FIG. 14 (b), also in such electrode structures, linear abnormal alignment regions are provided continuously along the linear portions 11b between the protruding portions 11c on the slits 11a. The protruding portions 11c are provided in the entire pixel in this manner, so that the alignment state of the liquid crystal molecules in the pixel may be made uniform.

As shown in FIG. 13(a) and FIG. 14 (a), the protruding portions 11c may be shifted by half pitch between two adjacent linear portions 11b. The linear abnormal alignment regions are formed from the protruding portions 11c, and the recessed portions 11e are considered to have almost no influence on occurrence of the alignment abnormality. Therefore, in this embodiment also, the recessed portions 11e do not need to be provided.

A liquid crystal display panel including the upper electrode 11 shown in FIG. 13(a) or FIG. 14(a) includes a pair of horizontal alignment films located to have a liquid crystal layer therebetween. Since the liquid crystal molecules in the liquid crystal layer assume twisted alignment, the alignment control direction (in this example, rubbing direction) is different by 90 degrees between the horizontal alignment film on the front substrate side and the horizontal alignment film on the rear substrate side. Such alignment control directions were made the same in the embodiment shown in FIG. 13(a) and in the embodiment shown in FIG. 14(a) to perform an investigation. As can be confirmed from FIG. 13(b) and FIG. 14 (b), abnormal alignment regions were formed by the action of the protruding portions 11c in both cases. As can be seen from this, the protruding portions 11c may be provided along either edge of the linear portions 11b regardless of the alignment control directions of the alignment films.

FIG. 15(a) and FIG. 16(a) are each a plan view showing an upper electrode 11 in still another embodiments. In the upper electrode 11 shown in each of FIG. 15(a) and FIG. 16(a) also, each linear portion 11b has a plurality of protruding portions 11c. Between the protruding portions 11c, the linear portion 11b also has recessed portions 11e recessed from edges of the linear portion 11b toward a center line thereof. The recessed portions 11e are arranged in the direction in which the linear portion 11b extends.

Like in the upper electrode 11 shown in FIG. 12 (a), each linear portion 11b has the protruding portions 11c and the recessed portions 11e located alternately along the left and right edges thereof. Unlike in the upper electrode 11 shown in FIG. 12(a), the protruding portions 11c provided along two adjacent linear portions 11b are located to face each other while being slightly shifted from each other.

As a result, as in the areas enclosed by circles in FIG. 15 (a) and FIG. 16 (a), only one of the two protruding portion 11c facing each other is located in a portion of the slit 11a having the smallest width. Therefore, even in the case where the protruding portions 11c have a relatively large size, the width of the slit 11a may be made small without the two adjacent linear portions 11b being connected with each other.

As shown in FIG. 15 (b) and FIG. 16 (b), also in such electrode structures, linear abnormal alignment regions are provided continuously along the linear portions 11b between the protruding portions 11c on the slits 11a. The protruding portions 11c are provided in the entire pixel in this manner, so that the alignment state of the liquid crystal molecules in the pixel may be made uniform.

As shown in FIG. 15(a) and FIG. 16 (a), the protruding portions 11c may be shifted by half pitch between two adjacent linear portions 11b. As shown in FIG. 15(b) and FIG. 16 (b), the linear abnormal alignment regions are formed from the protruding portions 11c, and the recessed portions 11e are considered to have almost no influence on occurrence of the alignment abnormality. Therefore, in this embodiment also, the recessed portions 11e do not need to be provided. The protruding portions 11c may be located such that the narrow portions of the slit 11a are inverted S-shaped (FIG. 15(a)) or are S-shaped (FIG. 16(a)), regardless of the alignment control directions of the alignment films.

As described above, in the liquid crystal display device in this embodiment, each pixel may exhibit the black display state, the white display state and the transparent display state in a switched manner. A conventional see-through display device provides see-through display in either the black display state or the white display state regardless of the type thereof (liquid crystal display device, PDLC display, organic EL display, etc.) (namely, the gray scale level corresponding to the black display state or the white display state is assigned to the see-through display). Therefore, see-through display is not provided at an applied voltage different from both of the voltage for the black display state and the voltage for the white display state. By contrast, in the liquid crystal display device in this embodiment, each pixel may exhibit the black display state, the white display state, and also the transparent display state provided at a voltage different from both of the voltage for the black display state and the voltage for the white display state. Therefore, the display is prevented from being blurred (from being visually recognized double). In the liquid crystal display device in this embodiment, the linear portions 11b of the upper electrode 11 each have protruding portions 11c protruding toward the adjacent linear portion 11b, so that the display quality is suppressed from being declined by abnormal alignment change at the time of gray scale level transition.

In this embodiment, in the transparent display state, the liquid crystal molecules 31 in the liquid crystal layer 30 assume twisted alignment. This realizes clearer transparent display for the following reason. When assuming twisted alignment, the liquid crystal molecules 31 are oriented in the same direction in a plane parallel to the display surface. Therefore, there is no diffraction caused by the refractive index difference in the plane or diffraction by the dark line caused by the liquid crystal mode (dark line caused by a structural body controlling the alignment direction or dark line by discontinuity in the alignment direction caused in the plane).

In this example, in the white display state and the transparent display state, the liquid crystal molecules 31 at, and in the vicinity of, the central portion of the liquid crystal layer 30 in the thickness direction are aligned to be generally perpendicular to the slit direction D (namely, the average alignment direction of the bulk liquid crystal portion is generally perpendicular to the slit direction D). Alternatively, the liquid crystal molecules 31 at, and in the vicinity of, the central portion of the liquid crystal layer 30 in the thickness direction may be aligned to be generally parallel to the slit direction D (namely, the average alignment direction of the bulk liquid crystal portion is generally parallel to the slit direction D). It should be noted that the former structure (hereinafter, also referred to as a “perpendicular type structure”) is preferable to the latter structure (hereinafter, also referred to as a “parallel type structure”) from the point of view of display brightness.

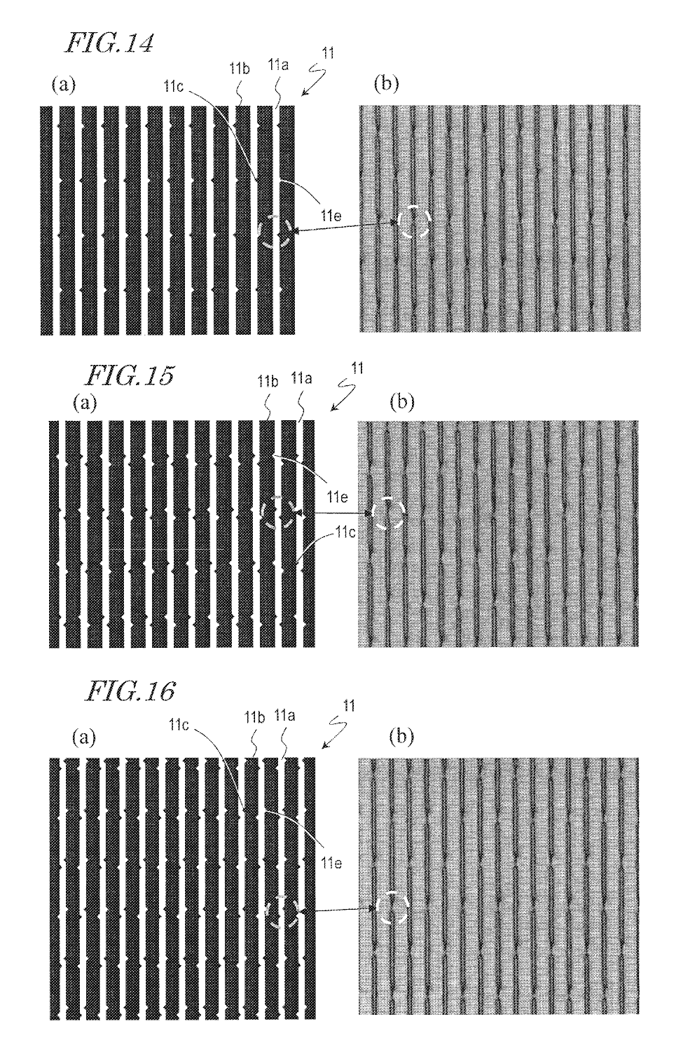

Still alternatively, as in a liquid crystal display device 100′ shown in FIG. 17 and FIG. 18, the liquid crystal molecules 31 in the liquid crystal layer 30 may assume homogeneous alignment in the transparent display state.

In the liquid crystal display device 100′, the pretilt directions respectively controlled by the first horizontal alignment film 14 and the second horizontal alignment state 24 are set such that the liquid crystal molecules 31 assume homogeneous alignment in the state where no voltage is applied to the liquid crystal layer 30 (in the state where no electric field is generated). Specifically, the pretilt directions respectively controlled by the first horizontal alignment film 14 and the second horizontal alignment state 24 are generally perpendicular to the direction in which the slits 11a of the upper electrode 11 extend (generally perpendicular to the slit direction D). Namely, the pretilt direction controlled by the first horizontal alignment film 14 and the pretilt direction controlled by the second horizontal alignment film 24 are parallel or antiparallel to each other.

The transmission axes 15a and 25a of the first polarization plate 15 and the second polarization plate 25 have an angle of about 45 degrees with respect to the pretilt directions respectively controlled by the first horizontal alignment film 14 and the second horizontal alignment film 24. Therefore, the transmission axes 15a and 25a of the first polarization plate 15 and the second polarization plate 25 have an angle of about 45 degrees with respect to the slit direction D.

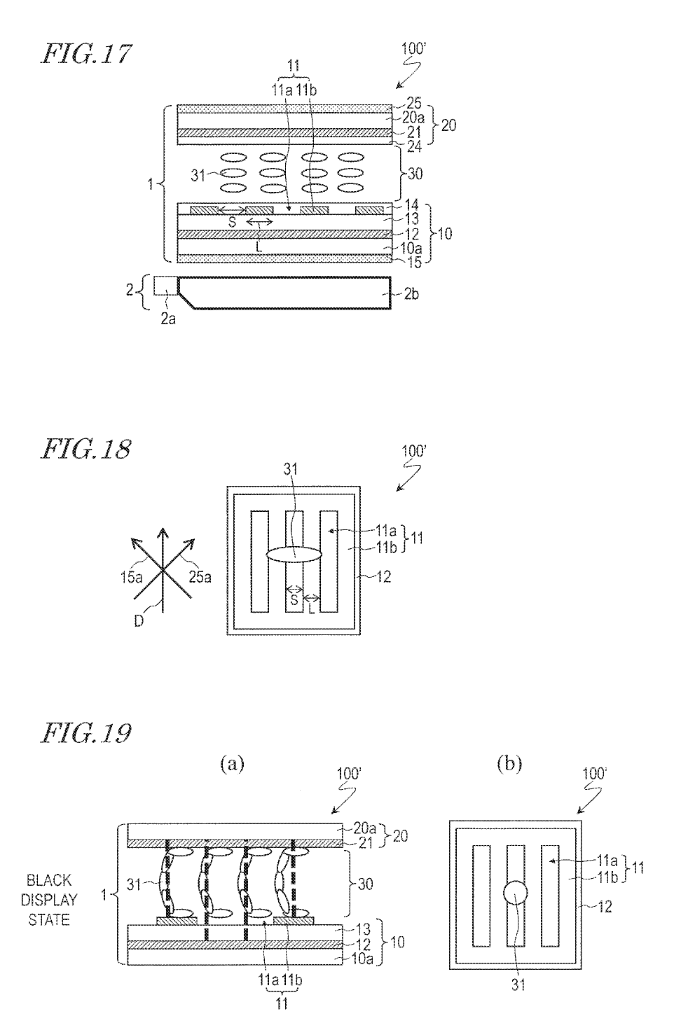

FIG. 19(a) and FIG. 19(b) show an alignment state of the liquid crystal molecules 31 in the black display state. In the black display state, a predetermined voltage is applied between the counter electrode 21 and the upper electrode 11/lower electrode 12 (for example, potentials of 7 V, 7.5 V and 0 V are respectively given to the upper electrode 11, the lower electrode 12 and the counter electrode 21), and a vertical electric field is generated in the liquid crystal layer 30. FIG. 19(a) schematically shows line of electric force in this state with dashed lines.

In the black display state, as shown in FIG. 19(a) and FIG. 19 (b), the liquid crystal molecules 31 in the liquid crystal layer 30 are aligned to be generally vertical to the substrate surface (surfaces of the rear substrate 10 and the front substrate 20) (namely, aligned to be generally parallel to the normal to the liquid crystal layer 30).

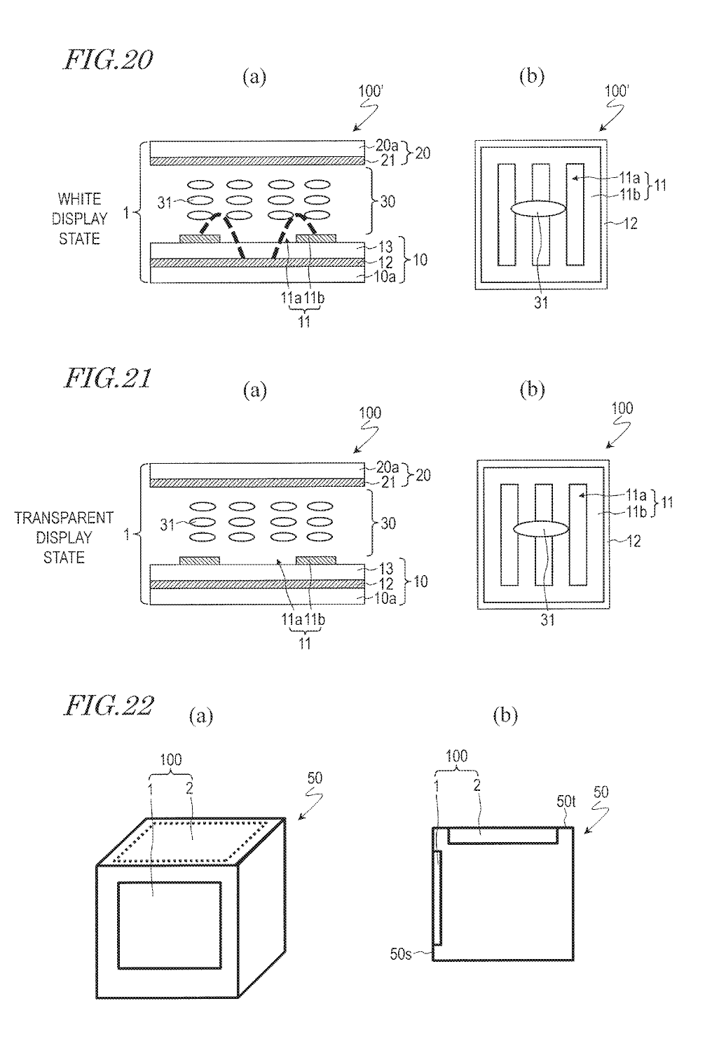

FIG. 20(a) and FIG. 20(b) show an alignment state of the liquid crystal molecules 31 in the white display state. In the white display state, a predetermined voltage is applied between the upper electrode 11 and the lower electrode 12 (for example, potentials of 0 V, 7.5 V and 0 V are respectively given to the upper electrode 11, the lower electrode 12 and the counter electrode 21), and a lateral electric field (fringe field) is generated in the liquid crystal layer 30. FIG. 20(a) schematically shows line of electric force in this state with dashed lines.

In the white display state, as shown in FIG. 20(a) and FIG. 20(b), the liquid crystal molecules 31 in the liquid crystal layer 30 are aligned to be generally parallel to the substrate surface (namely, aligned to be generally vertical to the normal to the liquid crystal layer 30). More specifically, the liquid crystal molecules 31 are aligned to be generally perpendicular to the direction D in which the slits 11a of the upper electrode 11 extend. Namely, the liquid crystal molecules 31 are aligned to have an angle of about 45 degrees with respect to the transmission axes 15a and 25a of the first polarization plate 15 and the second polarization plate 25.

FIG. 21(a) and FIG. 21(b) show an alignment state of the liquid crystal molecules 31 in the transparent display state. In the transparent display state, no voltage is applied to the liquid crystal layer 30 (for example, a potential of 0 V is given to all of the upper electrode 11, the lower electrode 12 and the counter electrode 21), and neither a vertical electric field nor a lateral electric field is generated in the liquid crystal layer 30.

In the transparent display state, as shown in FIG. 21(a) and FIG. 21(b), the liquid crystal molecules 31 in the liquid crystal layer 30 assume homogeneous alignment. Namely, the liquid crystal molecules 31 are aligned to be generally parallel to the substrate surface (namely, aligned to be generally vertical to the normal to the liquid crystal layer 30). More specifically, the liquid crystal molecules 31 are aligned to be generally perpendicular to the direction D in which the slits 11a of the upper electrode 11 extend. Namely, the liquid crystal molecules 31 are aligned to have an angle of about 45 degrees with respect to the transmission axes 15a and 25a of the first polarization plate 15 and the second polarization plate 25. In this transparent display state, pixels in the liquid crystal display device 100′ have a highest light transmittance (namely, higher light transmittance than in the black display state or the white display state).

Also in the liquid crystal display device 100′, a vertical electric field is generated in the liquid crystal layer 30 in the black display state and a lateral electric field is generated in the liquid crystal layer 30 in the white display state. Therefore, a torque by voltage application acts on the liquid crystal molecules 31 in both of the fall (transition from the white display state to the black display state) and the rise (transition from the black display state to the white display state), and thus a high speed response characteristic is provided. Each of the pixels may exhibit the black display state, the white display state, and also the transparent display state in which no voltage is applied to the liquid crystal layer 30. Therefore, the problem that the background is blurred (visually recognized double) is prevented. In addition, the linear portions 11b of the upper electrode 11 have the protruding portions 11c protruding toward the adjacent linear portion 11b, so that the display quality is suppressed from being declined by the abnormal alignment change at the time of gray scale level transition.

FIG. 1 and FIG. 17 show a structure in which the backlight unit of the edge light system as the illumination element 2 is located on the rear side of the liquid crystal display panel 1 so as to overlap the liquid crystal display panel 1. The illumination element 2 is not limited to being provided in this manner.

For example, the structure shown in FIG. 22 may be adopted. In the structure shown in FIG. 22, the liquid crystal display panel 1 and the illumination element 2 of the liquid crystal display device 100 (or the liquid crystal display device 100′) are attached to a box-shaped transparent case 50. The case 50 having the liquid crystal display panel 1 and the illumination element 2 attached thereto is used as, for example, a showcase.

The liquid crystal display panel 1 is attached to a side surface 50s among a plurality of side surfaces of the case 50. The illumination element 2 is attached to a top surface 50t of the case 50. As described above, the illumination element 2 may direct light of a plurality of colors including red light, green light and blue light in a switched manner toward the liquid crystal display panel 1. From the point of view of increasing the light utilization factor (from the point of view of causing light from the illumination element 2 in as much amount as possible to be incident on the liquid crystal display panel 1), it is preferable that an inner surface of the case 50 is light-diffusive.

In the above, color display provided in the field sequential system is described. The liquid crystal display device in an embodiment according to the present invention is not limited to a liquid crystal display device providing color display in the field sequential system. Even a liquid crystal display device including a liquid crystal display panel that includes a color filter prevents display from being blurred (from being visually recognized double) as long as the pixels exhibit the black display state, the white display state and the transparent display state in a switched manner.

### INDUSTRIAL APPLICABILITY

An embodiment according to the present invention provides a liquid crystal display device that has a high response characteristic and also provides a high display quality and is preferably usable as a see-through display device. The liquid crystal display device (see-through display device) in an embodiment according to the present invention is usable as a display device for, for example, illumination display or digital signage.

### REFERENCE SIGNS LIST

1 Liquid crystal display panel
2 Illumination element
2a Light source unit
2b Light guide plate
10 First substrate (rear substrate)
10a Transparent substrate
11 First electrode (upper electrode)
11a Slit
11b Linear portion
11c Protruding portion
11d Frame region
11e Recessed portion
12 Second electrode (lower electrode)
13 Insulating layer
14 First horizontal alignment film
15 First polarization plate
15a Transmission axis of the first polarization plate
16A First TFT
16B Second TFT
17 Gate bus line
18 Source bus line
20 Second substrate (front substrate)
20a Transparent substrate
21 Third electrode (counter electrode)
24 Second horizontal alignment film
25 Second polarization plate
25a Transmission axis of the second polarization plate
30 Liquid crystal layer
31 Liquid crystal molecule
50 Case
100, 100′ Liquid crystal display device

1. A liquid crystal display device, comprising:
a liquid crystal display panel including a first substrate and a second substrate facing each other, and a liquid crystal layer provided between the first substrate and the second substrate; the liquid crystal display device including a plurality of pixels arrayed in a matrix;
wherein:
the first substrate includes a first electrode provided in each of the plurality of pixels and a second electrode provided below the first electrode with an insulating layer being provided between the first electrode and the second electrode, the second electrode generating a lateral electric field in the liquid crystal layer together with the first electrode;
the second substrate includes a third electrode provided to face the first electrode and the second electrode, the third electrode generating a vertical electric field in the liquid crystal layer together with the first electrode and the second electrode;
the plurality of pixels each exhibit, in a switched manner,
a black display state where black display is provided in a state where the vertical electric field is generated in the liquid crystal layer,
a white display state where white display is provided in a state where the lateral electric field is generated in the liquid crystal layer, and
a transparent display state where a rear side of the liquid crystal display panel is seen through in a state where no voltage is applied to the liquid crystal layer; and
the first electrode includes first and second linear portions located parallel to each other with a gap being provided there between and a protruding portion protruding from one of the first linear portion and the second linear portion toward the other of the first linear portion and the second linear portion.

2. The liquid crystal display device according to claim 1, wherein a plurality of the protruding portions are provided in a direction in which the first linear portion extends.

3. The liquid crystal display device according to claim 2, wherein the plurality of protruding portions are located at substantially the same pitch.

4. The liquid crystal display device according to claim 1, wherein the first electrode further includes:
a third linear portion located on a side opposite to the first linear portion with respect to the second linear portion, the third linear portion being located parallel to the second linear portion and with a gap being provided between the second linear portion and the third linear portion; and
a protruding portion protruding from one of the second linear portion and the third linear portion toward the other of the second linear portion and the third linear portion.

5. The liquid crystal display device according to claim 4, wherein the protruding portion provided between the first linear portion and the second linear portion, and the protruding portion provided between the second linear portion and the third linear portion, are located at positions shifted from each other with respect to a direction perpendicular to a direction in which the first, second and third linear portions extend.

6. The liquid crystal display device according to claim 1, wherein the protruding portion protruding from the one of the linear portions does not reach the other of the linear portions.

7. The liquid crystal display device according to claim 1, wherein the first electrode further includes a protruding portion protruding from the other of the linear portions toward the one of the linear portions.

8. The liquid crystal display device according to claim 7, wherein the protruding portion protruding from the one of the linear portions toward the other of the liner portions, and the protruding portion protruding from the other of the linear portions toward the one of the linear portions, face each other.

9. The liquid crystal display device according to claim 1, wherein the one of the linear portions has a recessed portion recessed in a direction from the other of the linear portions toward the one of the linear portions.

10. The liquid crystal display device according to claim 1, wherein liquid crystal molecules in the liquid crystal layer assume twisted alignment in the transparent display state.

11. The liquid crystal display device according to claim 10, wherein:
the first electrode includes a plurality of slits extending in a predetermined direction; and
in the white display state and the transparent display state, liquid crystal molecules at, and in the vicinity of, a central portion of the liquid crystal layer in a thickness direction are aligned to be generally perpendicular to the predetermined direction.

12. The liquid crystal display device according to claim 1, further comprising an illumination element directing light of a plurality of colors including red light, green light and blue light in a switched manner toward the liquid crystal display panel.

13. The liquid crystal display device according to claim 1, wherein the liquid crystal display device provides color display in a field sequential system.

14. The liquid crystal display device according to claim 1, wherein the liquid crystal display panel does not include a color filter.
